(19) United States
(12) Patent Application Publication
(10) Pub. No.: US 2006/0187692 A1
(43) Pub. Date: Aug. 24, 2006

(54) Output voltage control of a synchronous rectifier

(76) Inventors: Reinhold Elferich, Aachen (DE); Thomas Durbaum, Baiersdorf (DE); Tobias Georg Tolle, Aachen (DE); Raymond Grover, Manchester (GB); Philip Rutter, Stockport, Cheshire (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/566,803

(22) PCT Filed: Jul. 22, 2004
(86) PCT No.: PCT/IB04/51283

§ 371 Date: Jan. 30, 2006

(30) Foreign Application Priority Data
Aug. 1, 2003 (EP) 03102401.1

(51) Int. Cl. H02M 7/00

(52) U.S. Cl. 363/125

(57) ABSTRACT

The trend towards more digital signal processing in mains-powered devices causes an increasing variety of supply voltages at ever decreasing levels and at higher currents. At present, the secondary side architecture provides a separate ac-dc conversion and dc-dc down-conversion stages in order to obtain stabilized voltages at those low levels. According to the present invention, a controlling synchronous rectifier is provided, comprising a power MOSFET and a control unit which allow to integrate both stages. In particular, according to the present invention, the output voltage of the synchronous rectifier is controlled by controlling the channel switching of the MOSFET. Advantageously, this provides for a very simple and efficient rectification and voltage control.

The present invention relates to a method of operating a synchronous rectifier comprising a MOSFET, to a synchronous rectifier and to an output voltage control circuit for controlling an output voltage of a synchronous rectifier.

The trend towards more digital signal processing in mains-powered devices causes an increasing variety of supply voltages with increasing voltage levels and higher currents. The power supply unit of those devices comprises a primary and a secondary side. The primary side is formed by an input circuit for rectifying and filtering the mains voltage, a primary side switching means and a transformer for generating one or more secondary winding ac-voltages. The secondary side architecture provides rectifiers and filters for ac-dc conversion and optionally dc-dc step-down conversion stages at one or more outputs in order to obtain stabilized output voltages with a low voltage level. Thus, two separate circuitries have to be provided.

It is an object of the present invention to provide for a simplified synchronous rectification, allowing for a low level voltage output.

According to an exemplary embodiment of the present invention as set forth in claim 1, the above object may be solved with a method of operating a synchronous rectifier comprising a MOSFET. According to this exemplary embodiment of the present invention, an output voltage of the synchronous rectifier is controlled by controlling the channel switching of the MOSFET.

By this, a combination of the rectification and the control of the output voltage may be combined into one circuitry and into one functional element.

According to an aspect of this exemplary embodiment of the present invention, a semi-conductor junction of the MOSFET, the behavior of which may be described as a diode, is used for controlling the output voltage of the rectifier. The usable control headroom may be provided by the intrinsic diode's forward voltage drop.

According to an aspect of this exemplary embodiment of the present invention, the switching of the MOSFET is controlled such that a switching is performed between only two states, namely a first state, where the MOSFET is switched on (i.e. conductive) and a second state where the MOSFET is switched off (i.e. non-conductive).

Advantageously, this may provide for a very simple and cost effective solution, since, in comparison to the prior art, at least one complete down-converter may be omitted. Furthermore, the synchronous rectification and the voltage control may be provided with an improved efficiency with respect to common diode rectifier plus down-converter solutions or even with respect to synchronous rectifier plus down-converter solutions.

According to another exemplary embodiment of the present invention as set forth in claim 2, a leading edge control of the channel switching of the MOSFETs is performed. Here, after the forward voltage (anode-cathode voltage) of the MOSFET becomes positive, a delay is introduced, after which the channel of the MOSFET is switched on.

Advantageously, this leading edge control, according to an exemplary embodiment of the present invention, may allow for a simplified on-switching and may also provide for a simplified off-switching. No reverse recovery of the body diode occurs here, since, at the time of the off-switching, the diode is not conductive.

According to another exemplary embodiment of the present invention as set forth in claim 3, this delay is determined on the basis of a control error voltage. Advantageously, this exemplary embodiment allows for a very simple and efficient operation.

According to another exemplary embodiment of the present invention as set forth in claim 4, a falling edge control of the channel switching of the MOSFET is performed. Here, the channel of the MOSFET is switched on (i.e. conductive) directly after the determination of a positive sign change of a channel voltage, such that the channel voltage becomes positive. Then, the channel of the MOSFET is switched off, after a delay time. According to another exemplary embodiment of the present invention as set forth in claim 5, this delay time is determined on the basis of a control error voltage.

According to this exemplary embodiment of the present invention, oscillation problems which may occur during the on-switching, may be reduced. Such oscillation problems may occur due to the abrupt reduction of the forward voltage during the on-switching of the FET after a positive zero point crossing has been detected at the forward voltage. Here, to avoid such oscillations, a dead time is introduced.

According to another exemplary embodiment of the present invention as set forth in claim 6, the channel switching of the MOSFET is duty cycle modulated.

The duty cycle or PWM method according to this exemplary embodiment of the present invention, may be particularly advantageous for lower frequencies.

According to another exemplary embodiment of the present invention as set forth in claim 8, a low-pass filtering of the output voltage of the synchronous rectifier is performed. Then, the channel switching of the MOSFET is performed on the basis of the low-pass filtered output voltage.

Advantageously, according to this time average control, according to an exemplary embodiment of the present invention, only a minimal number of switching processes occurs.

Also, the time average control, according to this exemplary embodiment of the present invention, allows for a very simple way to control the output voltage on a cycle-by-cycle basis.

According to another exemplary embodiment of the present invention as set forth in claim 9, a synchronous rectifier is provided, comprising an output voltage control circuit for controlling an output voltage of the synchronous rectifier by controlling the channel switching of the MOSFET.

The synchronous rectifier according to this exemplary embodiment, advantageously allows for a very cost effective solution, where the function of rectifying the voltage and controlling the output voltage is combined into one component. Thus, further components may be obviated. Furthermore, the synchronous rectifier according to this exemplary embodiment of the present invention, is very efficient, in particular at high currents. Also, the synchronous rectifier according to this exemplary embodiment of the present invention, may provide for a reduced overall size and a reduced component count. Also, due to the fact an increased efficiency may be provided, less cooling means are necessary. Furthermore, the synchronous rectifier according to this exemplary embodiment of the present invention is usable in a variety of low voltage power supply applications.

Claim 10 provides for another exemplary embodiment of the synchronous rectifier according to the present invention, which, advantageously, may allow for a very simple and efficient operation.

According to another exemplary embodiment of the present invention as set forth in claim 11, a synchronous rectifier is provided, including a plurality of MOSFETs and a plurality of output voltage control circuits associated with the respective MOSFETs for controlling the respective output voltages of the synchronous rectifier by controlling the channel switching of the respective MOSFETs. In particular, according to an aspect of this exemplary embodiment, the output voltages of the synchronous rectifier are stacked onto each other such that a very efficient and accurate control over an enlarged control headroom may be provided.

According to another exemplary embodiment of the present invention as set forth in claim 12, the MOSFET and the voltage control circuit are integrated in one package.

According to another exemplary embodiment of the present invention as set forth in claim 13, an output voltage control circuit is provided for controlling an output voltage of a synchronous rectifier. According to this exemplary embodiment of the present invention, the output voltage control circuit controls the output voltage of the synchronous rectifier by controlling the channel switching of the MOSFET. Advantageously, this output voltage control circuit may be applied to a power MOSFET, such that a synchronous rectifier may be provided, which allows for a controlled low voltage output.

It may be seen as the gist of an exemplary embodiment of the present invention that two functions are combined into one component, namely the rectifying function and the low output voltage control function are both combined into a component including a MOSFET and an output voltage control circuit connected to the gate of the MOSFET. The output voltage of the circuitry according to the present invention is controlled by accordingly controlling the channel switching of the MOSFET. Here, the inventive concept of the present invention makes use of the intrinsic diode's forward voltage drop of a MOSFET. This voltage drop of approximately 0.7V to 0.9V is the intrinsic usable control headroom which may be used by switching the channel.

These and other aspects of the present invention will become apparent from and elucidated with reference to the embodiments described hereinafter.

Exemplary embodiments of the present invention will be described in the following with reference to the following drawings:

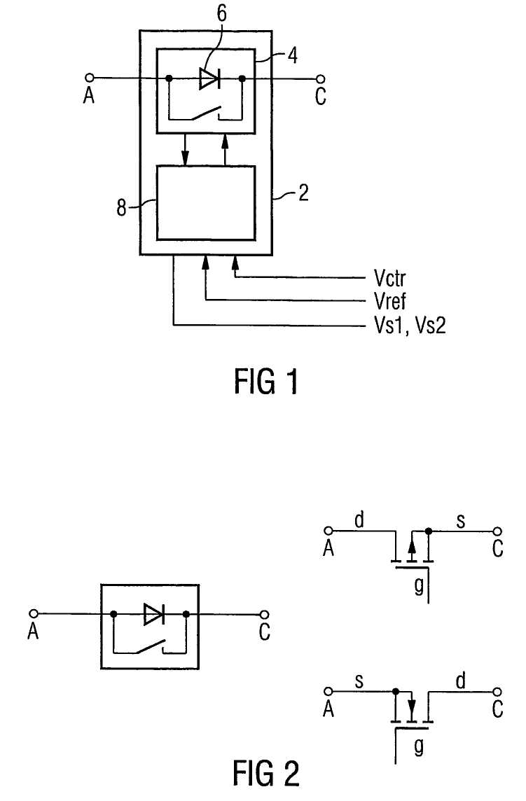

FIG. 1 shows a simplified circuit diagram of a first exemplary embodiment of a synchronous rectifier according to the present invention.

FIG. 2 shows a notation for p-and n-channel MOSFETs in which the upper figure refers to a p-channel and the lower to an n-channel type.

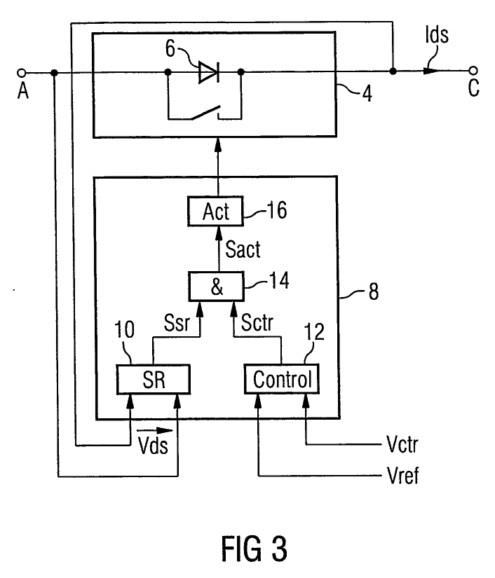

FIG. 3 shows a simplified circuit diagram of a second exemplary embodiment of a synchronous rectifier according to the present invention.

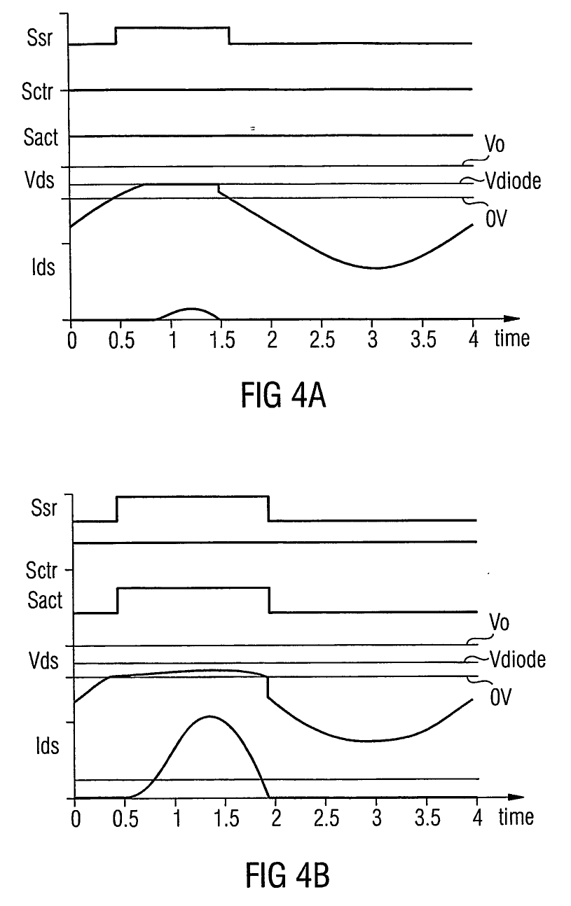

FIGS. 4a and 4b of FIG. 4 show timings of signals in the synchronous rectifier of FIG. 3.

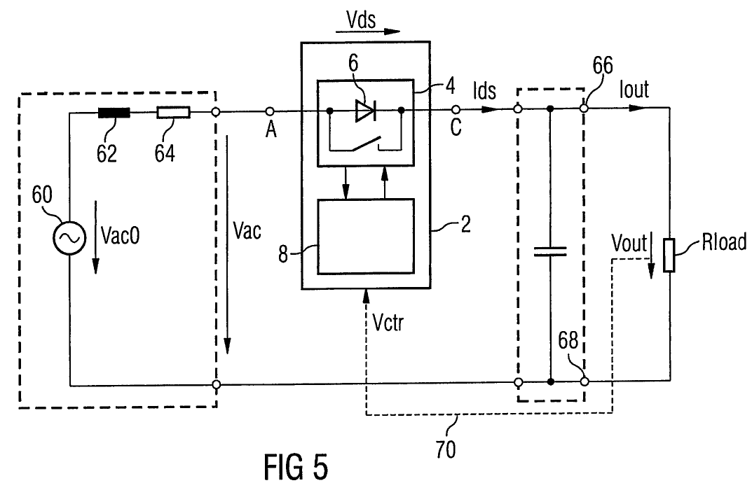

FIG. 5 shows a simplified circuit diagram for explaining how, for example, the first exemplary embodiment of a synchronous rectifier according to the present invention may be arranged in an electronic circuit according to the present invention.

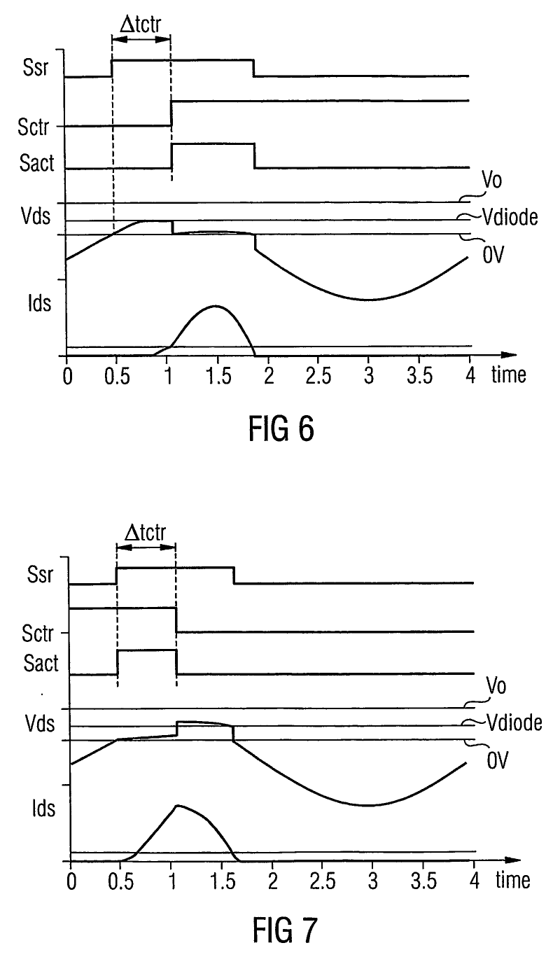

FIG. 6 shows timing charts of signals occurring in the synchronous rectifier of FIG. 3, operated in accordance with a first exemplary embodiment of a method according to the present invention.

FIG. 7 shows timing charts of the signals occurring in the synchronous rectifier of FIG. 3, operated in accordance with a second exemplary embodiment of a method according to the present invention.

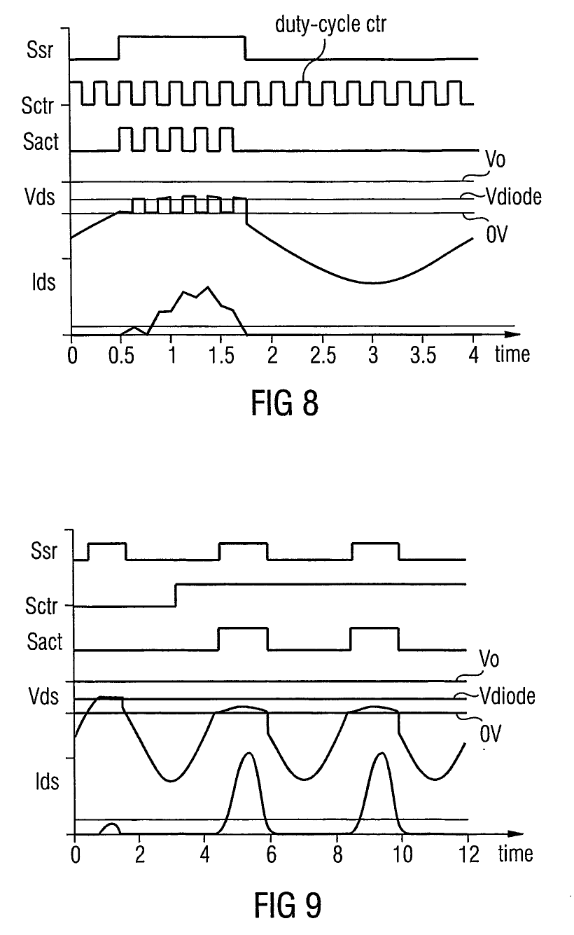

FIG. 8 shows timing charts of signals occurring in the synchronous rectifier of FIG. 3, operated in accordance with a third exemplary embodiment of a method according to the present invention.

FIG. 9 shows timing charts of signals occurring in the synchronous rectifier of FIG. 3 operated in accordance with a fourth exemplary embodiment of a method according to the present invention.

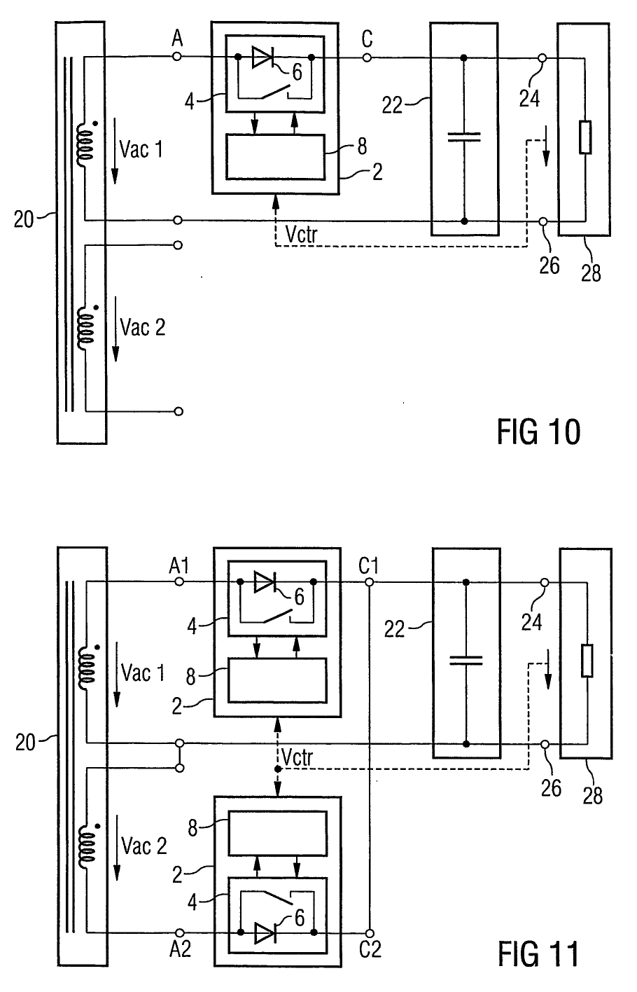

FIG. 10 shows a simplified circuit diagram of a third exemplary embodiment of a synchronous rectifier according to the present invention.

FIG. 11 shows a simplified circuit diagram of a fourth exemplary embodiment of a synchronous rectifier according to the present invention.

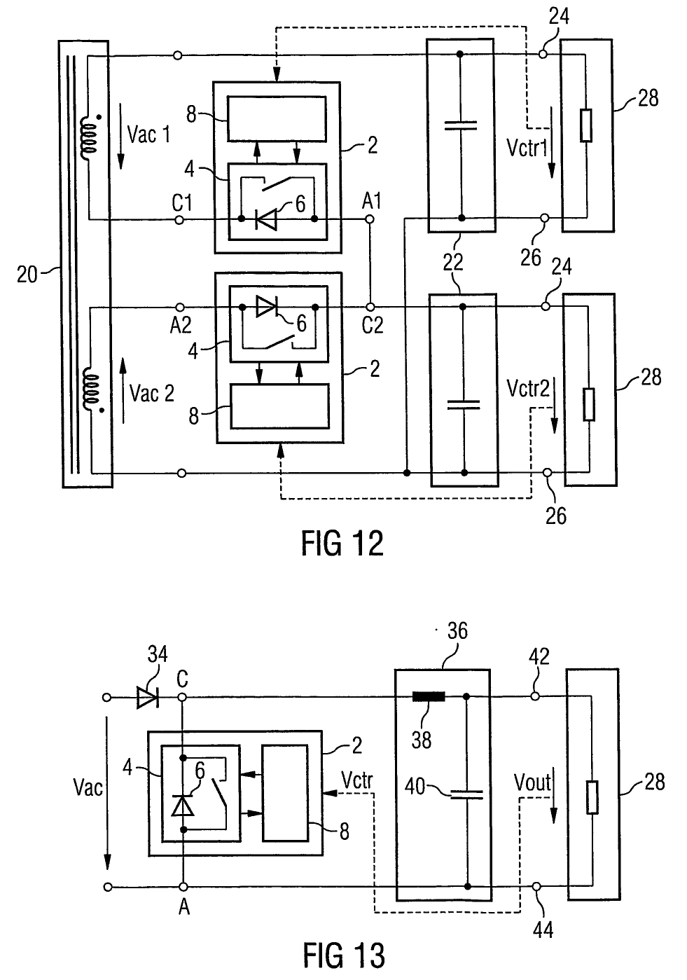

FIG. 12 shows a simplified circuit diagram of a fifth exemplary embodiment of a synchronous rectifier according to the present invention.

FIG. 13 shows a simplified circuit diagram of a sixth exemplary embodiment of a synchronous rectifier according to the present invention.

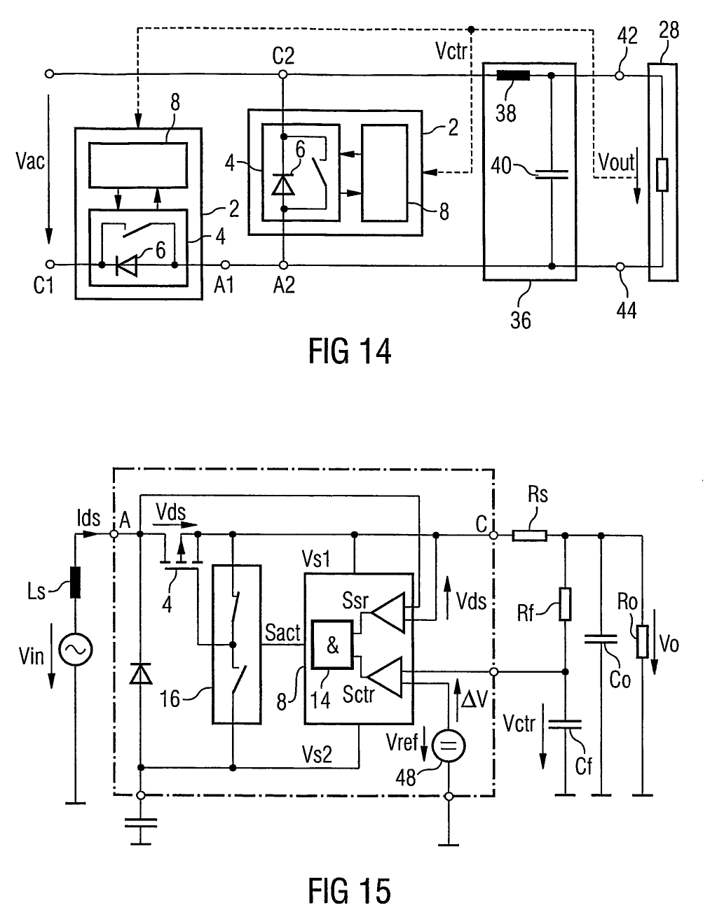

FIG. 14 shows a simplified circuit diagram of a seventh exemplary embodiment of a synchronous rectifier according to the present invention.

FIG. 15 shows a simplified circuit diagram of an eighth exemplary embodiment of a synchronous rectifier according to the present invention.

In the following description of exemplary embodiments of the present invention, throughout FIGS. 1 to 15, the same reference numerals are used to designate the same or corresponding elements in the Figures. The synchronous rectifier designated by reference numeral 2 throughout the Figures is not limited to the immediate element designated by reference numeral 4, but may be extended to the whole circuitry depicted in the respective Figures.

FIG. 1 shows a simplified circuit diagram of a first exemplary embodiment of a synchronous rectifier according to the present invention, comprising an output voltage control circuit according to an exemplary embodiment of the present invention. Reference numeral 2 designates the controlling synchronous rectifier according to the first exemplary embodiment of the present invention, comprising a MOSFET 4 and an output voltage control circuit 8 for controlling an output voltage of the synchronous rectifier 2 according to an exemplary embodiment of the present invention.

As may be taken from FIG. 1, a switching channel of the MOSFET 4 may be described by using a diode 6. This is due to the fact that the semi-conductor junction in the MOSFET has an electric behavior corresponding to the electric behavior of a diode. The anode and cathode terminals of the diode (the MOSFET), correspond to the switching channel of the MOSFET. There are further optional inputs for a controlled voltage (Vctr) and a reference voltage (Vref). Furthermore, there are provided optional supply terminals (Vs1 and Vs2). A control error, i.e. the deviation of the output voltage to the desired output voltage is set by Vref-Vctr.

According to an exemplary embodiment of the present invention, the output voltage control circuit controls a gate of the MOSFET 4, such that an output voltage of the synchronous rectifier 2 is controlled by the channel switching of the MOSFET 4, i.e. by the switching of the MOSFET 4. According to an aspect of this exemplary embodiment of the present invention, the output voltage control circuit 8 is adapted to determine a positive sign change of a channel voltage V_{ds}, i.e. the voltage across the channel of the MOSFET (the voltage across the diode 6). A positive sign change is such that the channel voltage becomes positive. Then, an on-switching of the channel of the MOSFET is performed a first time period after the positive sign change of the channel voltage. This first time period is determined on the basis of the control error Vref-Vctr.

According to another aspect of this exemplary embodiment of the present invention, the output voltage control circuit is adapted to determined the positive sign change of the channel voltage Vds and performs a control of the MOSFET 4, such that a channel of the MOSFET is switched on upon detection of the positive sign change. Then, an off-switching of the channel of the MOSFET is performed after a period of time, which is determined on the basis of the control error Vref-Vctr.

According to another aspect of this exemplary embodiment of the present invention, the output voltage control circuit is adapted to perform a control of the MOSFET 4, such that the switching of the MOSFET 4 is duty cycle modulated. The duty cycle is controlled on the basis of the control error Vref-Vctr. Advantageously, the duty cycle may be controlled such that the larger the control error Vref-Vctr, the larger the duty cycle.

According to another aspect of this exemplary embodiment of the present invention, the output voltage control circuit 8 is adapted to perform a low-pass filtering of the output voltage of the synchronous rectifier with a time constant larger than a period of an input voltage V_{ac} of the synchronous rectifier. Then, the channel switching is performed on the basis of the low-pass filtered voltage.

As indicated in FIG. 2, showing a notation for p-and n-channel MOSFETs, the synchronous rectifier depicted in FIG. 1 may be implemented as an n- or p-channel type MOSFET, which is operated in the third (n-channel) or in the first (p-channel) quadrant of the MOSFET's drain current vs. drain source voltage curve family.

FIG. 3 shows a simplified circuit diagram of a second exemplary embodiment of a synchronous rectifier according to the present invention.

As may be taken from FIG. 3, the output voltage control circuit 8 according to this exemplary embodiment of the present invention, comprises a comparator SR 10, the inputs of which are connected to the anode terminal A and the cathode terminal. Thus, across the inputs of the comparator SR 10, there is the channel voltage Vds. The output signal Ssr of the comparator SR is output to an AND-gate 14. Reference numeral 12 designates a control circuit outputting a signal Sctr corresponding to the control error Vref-Vctr. The control circuit 12 generates the output signal Sctr on the basis of the input signals Vctr and Vref. The signal Sctr is input to the AND-gate 14. The output of the AND-gate 14, namely the signal Sact is output to a gate driver unit Act 16, which is provided for driving the gate of the MOSFET 4 and thus for switching the channel of the MOSFET 4.

The output voltage control circuit 8 according to this exemplary embodiment of the present invention is adapted to control the output voltage Vₒᵤₜ of the synchronous rectifier by controlling the channel switching of the MOSFET 4.

FIGS. 4a and 4b of FIG. 4 show simplified timing charts of signals occurring in the synchronous rectifier of FIG. 3 during the switching. FIG. 4a shows the signals occurring in a non-conductive state of the channel and FIG. 4b shows the signals occurring in the fully conductive state of the channel of the MOSFET 4 during one period of the ac-input voltage V_{ac}. The idealized signals depicted in FIGS. 4a and 4b occur at a synchronous rectifier in accordance with the simplified circuit diagram depicted in FIG. 3, (with a p-channel MOSFET). The output voltage is clamped to 1.8V. The forward diode voltage drop is 0.75V. The Rds (on) is 20 mΩ and an output track resistance is 10 mΩ. A secondary winding stray inductance is 25 nH and the input voltage is a sinus at an amplitude of 2.8 V an a frequency of 200 kHz. As mentioned above, in FIG. 4a, the channel of the MOSFET 4 is always non-conductive; in FIG. 4b the channel is open, corresponding to the signal Ssr, i.e. at positive forward voltages. The resulting average current in the latter case for the above mentioned parameters, is about 4 Amps.

As may be taken from FIG. 4a, in the non-conductive state, during the active signal Ssr, the drain source voltage Vds of the MOSFET reaches V_{diode}, i.e. the forward diode voltage drop. During this, there is a very small current Ids resulting in a load current Iout of about 0.3 A.

In contrast, as may be taken from FIG. 4b, during the active signals Ssr and Sact, the current Ids reaches a peak. This example shows that the circuit allows for large load variations while keeping the output voltage at a constant level.

FIG. 5 is a simplified circuit diagram showing the arrangement of a synchronous rectifier according to the present invention, such as the synchronous rectifier according to the first exemplary embodiment of the present invention, in an electronic circuit according to an exemplary embodiment of the present invention.

The voltage Vac0 may be an inner secondary side transformer voltage provided to the synchronous rectifier 2 via a resistor 64 and an inductance 62. The inductance 62 represents a secondary side leakage inductivity of the transformer and the resistor 64 may represent a winding or lay-out resistance of the transformer. The voltage across the diode 6, i.e. between the terminals A and C, may be referred to as forward voltage drop Vds over the rectifier 2 (anode A to cathode C). The current flowing through the MOSFET 4, is the current Ids. The voltage Vout between terminals 66 and 68 across a resistor Rload, is the output voltage of the synchronous rectifier 2, which is controlled by the channel switching of the MOSFET according to the present invention. Also, according to an aspect of the present invention, the channel switching performed at the MOSFET 4 is performed such that the MOSFET is switched between two states only, namely the switched on state, where the channel of the MOSFET is conductive, and the switched off state, where the channel of the MOSFET is non-conductive. According to an aspect of the present invention, there is no intermediate switching state between on and off.

The broken line 70 indicates that the control voltage Vctr is directly proportional to Vout or even equal to Vout.

In the following, exemplary embodiments of methods of operating the output voltage control circuit 8 are described with reference to FIGS. 6 to 9.

FIG. 6 shows timing charts of signals occurring in the synchronous rectifier of FIG. 3 operated in accordance with a first exemplary embodiment of a method according to the present invention. This method is referred to as leading edge control. As may be taken from FIG. 5, after a forward voltage (anode-cathode voltage V_{dc}) has become positive, a delay Δtctr is introduced, after which the channel is opened (is switched on). A length of this delay is determined in accordance with the control error Vref-Vctr. In accordance with an aspect of this exemplary embodiment of the present invention, the larger the control error, the shorter the delay time. In other words, in FIG. 6, a turn-on delay is used as a control means for controlling the output voltage of the synchronous rectifier.

Advantageously, this leading edge control allows a safe on-switching and a very efficient off-switching. Advantageously, due to this, no oscillations occur. Furthermore, no reverse recovery losses occur since, at the time of the off-switching, the diode is no longer conductive.

FIG. 7 shows timing charts of signals occurring in the synchronous rectifier of FIG. 3, operated in accordance with a second exemplary embodiment of a method according to the present invention. As may be taken from FIG. 7, in contrast to FIG. 6, the channel is opened, i.e. becomes conductive, right after the Ssr is received. To control the output voltage Vₒᵤₜ, a turn-off delay control is introduced for controlling the turn-off of the channel of the MOSFET 4. The turn-off delay time is determined in accordance with the control error. In accordance with an aspect of this exemplary embodiment of the present invention, the larger the control error, the longer the time delay. Thus, as may be taken from FIG. 7, right after Ssr and Sact become active, the current Ids shows a steep incline. Then, after Sctr and Sact are deactivated, Ids shows a decline. The method may also be referred to as falling edge control.

In this falling edge control, oscillations may occur due to the abrupt decrease of the forward voltage during the on-switching of the MOSFET after a positive zero crossing has been detected at the forward voltage. According to an aspect of this exemplary embodiment of the present invention, for the avoidance of such oscillations, a dead time may be introduced. Such dead time may be introduced between the detection of the Ssr signal and the release of the signal Sact. Due to this, advantageously, a higher voltage threshold may be set for the detection of the sign change.

In the case of high di/dt values (high operating frequency), a so-called reverse recovery current may occur through the diode at the end of the rectification cycle, which ideally is determined by the negative zero crossing of the current. Due to this reverse recovery, however, the diode continues for a short time to conduct a current in the reverse direction.

FIG. 8 shows timing charts of signals occurring in the synchronous rectifier of FIG. 3 operated in accordance with a third exemplary embodiment of a method according to the present invention. This exemplary embodiment of the present invention is referred to as duty cycle control. As may be taken from FIG. 8, the control signal Sctr generated by the control signal 12 is generated such that it has a duty cycle. This causes a reflection of the duty cycle of Sctr onto the activation signal Sact. Thus, the channel switching of the MOSFET is duty cycle modulated. By controlling the duty cycle, the output voltage Vₒᵤₜ of the synchronous rectifier may be controlled.

As may be taken from FIG. 8, the duty cycle of the activation signal Sact is reflected onto the voltage Vds and onto the current Ids, (which shows an incline after the duty cycle occurs on the signal Sact up to a maxima, from which it declines). According to an aspect of this exemplary embodiment of the present invention, the larger the control error, the larger the duty cycle. In other words, the control circuit 12 in accordance with an aspect of the present invention, generates a duty cycle corresponding to the control error.

This duty cycle control may be in particular advantageous for lower frequencies of the voltage to be rectified. Advantageously, the PWM frequency should be higher than the frequency of the voltage to be rectified. Preferably, the PWM frequency is approximately ten times the voltage to be rectified. However, due to the fact that each switching may cause losses, according to an aspect of the present invention, the switching frequency is kept low.

According to an aspect of this exemplary embodiment of the present invention, the Ssr signal is synchronized to the PWM signal such that, during the on-switching, the PWM signal is on low.

FIG. 9 shows time charts of signals occurring in the synchronous rectifier of FIG. 3 operated in accordance with a fourth exemplary embodiment of a method according to the present invention. The method according to this exemplary embodiment of the present invention may also be referred to as time average control. According to this exemplary embodiment of the present invention, the control error is derived by low-pass filtering the output voltage Vₒᵤₜ. For this, the control circuit 12 may contain a low-pass filter, filtering the output voltage Vₒᵤₜ with a time constant which is, for example, one order of magnitude larger than a period of the input voltage Vᵢₙ. Thus, during a signal cycle, the channel is either switched on or off. The larger the control error, the higher the percentage of the cycles operated with a conductive channel. In the embodiment depicted in FIG. 15, such low-pass filtering of the output voltage is performed with the resistor Rs and the capacitance Cs.

FIG. 9 shows the cycle-by-cycle approach for three cycles. As may be taken from FIG. 8, during the first active portion of Ssr, the Ids is almost 0. During the subsequent two active cycles of Ssr, Ids respectively reaches maxima.

Advantageously, a minimal amount of switching processes are necessary in the time average control. Thus, the losses which occur according to this method are also kept very low. However, in practical solutions, the time average control may be more advantageous for higher input frequencies, since, otherwise, the efforts necessary for the output filter may be too high.

Overall, with respect to their suitability for input frequencies, sketched along an increasing input frequency, the order of the above methods would be as follows: Duty cycle (PWM), falling edge, leading edge, time average. Thus, due to the fact that more and more higher operation frequencies are required in practical applications, the time average method may be the most advantageous, in particular due to its simple realization. However, also the leading edge control may also be advantageous in certain applications.

FIGS. 10 to 11 depict simplified circuit diagrams of further exemplary embodiments of synchronous rectifiers according to the present invention, which are suited for low output voltages, preferably <5V.

FIG. 10 shows a simplified circuit diagram of a third exemplary embodiment of a synchronous rectifier according to the present invention. The synchronous rectifier depicted in FIG. 9 is a single way rectifier application. The input voltage Vac1 . . . n is the secondary winding voltage of a transformer 20 of a multiple output power supply.

Power supply units typically provide one output voltage which is controlled by the primary side switching action. Due to the non-ideal behavior of the transformer and non-negligible impedances within the output circuits “cross-regulation errors” occur in the other-“cross-regulated”-outputs, which may result in non-tolerable output voltage fluctuations. Such “cross-regulation errors” strongly increase with decreasing secondary winding voltage levels of the transformer corresponding to high transformer turn-ratios since they are associated with high secondary winding leakage inductances. Such power supply units therefore not only provide output voltages regulated by the primary side switching action and such which are “cross-regulated”. They also comprise output circuits with additional post-regulation stages for providing stabilized output voltages particularly at low output voltage levels. Such post-regulation is typically performed by step-down converters.

The input signal of the synchronous rectifier 2 is the voltage Vctr across output terminals 24 and 26. Across the output terminals 24 and 26 (i.e. Vout) there is provided a load 28. The synchronous rectifier 2 according to this exemplary embodiment of the present invention is provided with an output filter 22, which is preferably a capacitive type output filter. However, according to an aspect of the present invention, it is also possible to provide a CLC pi-filter. Due to the provision of the output filter 22, the synchronous rectifier 2 in this application is rather suited for medium currents up to, for example, 5 A. Since the cathode C is clamped to a constant potential, a p-channel MOSFET might be advantageous in such applications.

According to an aspect of this exemplary embodiment of the present invention, the synchronous rectifier 2 may also be used in a ground line with a clamped anode (n-channel). However, multiple output transformers usually tend to have a common ground, which means that they are provided with less coil former pins.

FIG. 11 shows a simplified circuit diagram of a fourth exemplary embodiment of a synchronous rectifier according to the present invention. A comparison to FIG. 9 shows that there is provided another synchronous rectifier 2, the anode of which is clamped to a second secondary winding of the transformer 20. The cathodes C1 and C2 of the two synchronous rectifiers 2 are connected to each other. This exemplary embodiment of the present invention may also be referred to as a synchronous rectifier with common cathodes in a center tapped double-way rectifier configuration.

Advantageously, this exemplary embodiment of the present invention allows to use both half-waves to reduce the current ripple in the capacitive output filter. Advantageously, this may be of benefit, not only in terms of efficiency due to lower voltage drops at high currents, but also a problem of parameter-asymmetries of conventional diode rectified outputs regarding different transformer secondary winding leakage inductances and different diode forward voltage drops may be overcome, because both tracks are separately controllable by means of the output voltage control circuits 8.

FIG. 12 shows a simplified circuit diagram of a synchronous rectifier according to the present invention. As may be taken from a comparison of FIGS. 11 and 12, in contrast to the arrangement of FIG. 12, which requires two synchronous rectifiers 2 for one output, the fifth exemplary embodiment of the present invention depicted in FIG. 12 provides for a combination of two stabilized outputs while applying only two synchronous rectifiers 2. As may be taken from FIG. 12, the anode A1 of the upper synchronous rectifier 2 is connected to the cathode

C2 of the lower synchronous rectifier. Each of the synchronous rectifiers is provided with an output filter 22.

Advantageously, the circuitry depicted in FIG. 12 allows that the first output voltage Vctr1 may be controlled at higher voltages, since it is stacked onto the second output voltage Vctr2. Thus, the control headroom provided by the diode 6 is used in series, i.e. is doubled. Thus, a very efficient and accurate control over an enlarged control headroom is provided. Furthermore, the first outputs providing the first output voltage Vctr1 is energized by both half-waves, which, advantageously, allows to reduce a ripple current. Furthermore, advantageously, the lower synchronous rectifier 2 is loaded by both currents.

Thus, for example, a circuitry may be provided, providing for a controlled low output voltage Vctr2, with, for example, 1.8V and a medium output voltage Vctr1, with, for example, 3.3V in a stacked configuration.

FIG. 13 shows a circuit diagram of a sixth exemplary embodiment of a synchronous rectifier according to the present invention.

The configurations of the synchronous rectifier depicted in FIGS. 13 and 14 are advantageously adapted for low voltage outputs and are provided with inductive filters for higher output currents. Both configurations, i.e. the circuit configuration depicted in FIG. 13 and the circuit configuration depicted in FIG. 14 may advantageously be employed in “forward outputs” configurations. These output types are advantageously used for higher currents, and, according to an aspect of the present invention, are provided with a second rectifier, which is preferably a free-wheeling rectifier.

As depicted in FIG. 13, the input voltage Vac is applied via a diode 34 to the anode and cathode of the MOSFET 4. The output voltage control circuit 8 is provided with the output voltage Vₒᵤₜ across the output terminals 42 and 44. Across the output terminals 42 and 44 there is also provided a filter, including a capacitance 40 and an inductance 38.

Advantageously, the synchronous rectifier depicted in FIG. 13 provides for a very effective way of controlling the output voltage Vₒᵤₜ.

FIG. 14 shows a simplified circuit diagram of a seventh exemplary embodiment of a synchronous rectifier according to the present invention.

As may be taken from FIG. 14, there are provided two synchronous rectifiers 2. The input voltage Vac is provided between the cathode C2 of the right synchronous rectifier 2 in FIG. 13 and the cathode C1 of the left synchronous rectifier 2 of FIG. 13. The anode A1 of the left synchronous rectifier 2 and the anode A2 of the right synchronous rectifier 2 are connected to each other. The output terminals 42 and 44 are provided across the cathode C2 of the right synchronous rectifier 2 and the anode A2 of the right synchronous rectifier 2.

Advantageously, by the use of two synchronous rectifiers as depicted in the seventh exemplary embodiment depicted in FIG. 14, a very high efficiency may be achieved, as well as allowing for higher controllable voltages Vₒᵤₜ, which is applied as control voltages Vctr to the upper voltage control circuits 8 of the left and right synchronous rectifiers 2.

Thus, the simple arrangement depicted in FIG. 14, with two synchronous rectifiers 2 with common clamped anodes (in-channel), allows for an increased control headroom and an increased efficiency.

FIG. 15 shows a simplified circuit diagram of an eighth exemplary embodiment of a synchronous rectifier according to the present invention. As may be taken from FIG. 15, the synchronous rectifier depicted in FIG. 15 is implemented with a p-channel MOSFET in a single way rectifier application with a capacitive output filter Co. The control voltage Vctr is taken across Cs. The reference voltage Vrev is provided by a reference voltage source 48. According to an aspect of this exemplary embodiment of the present invention, all elements encircled by the broken line may be integrated in a single package, i.e. may be integrated into a single IC housing. Advantageously, this may provide for a very small solution.

Furthermore, due to the integration of these elements into one single component, a component count may be reduced. Also, due to the increased efficiency (lower losses), cooling means with a reduced size may be used.

As may be taken from FIG. 15, the supply for the upper voltage control circuit 8 and the gate driver 16 is generated internally. Due to this, a fully integrated component may be provided, which requires less inputs and outputs. Furthermore, according to an aspect of this exemplary embodiment of the present invention, one or both supply voltages may be connected from the outside.

The resistor Rs represents a parasitic resistance of the output track (or connector resistance).

According to an aspect of this exemplary embodiment of the present invention, this resistance Rs may be negligible, which allows that the output voltage signal may be derived internally, i.e. within the integrated component as well.

According to an aspect of the present invention, during a start-up phase, an output capacitor of the exemplary embodiments of the present invention described above may already be charged by the diode of the MOSFET.

Advantageously, according to the present invention, a very cost efficient solution may be provided. In comparison to known solutions, at least one complete step-down-converter may be saved or omitted. Furthermore, a very efficient rectifying voltage control may be provided, in particular at high currents because the body diode of the MOSFET is conductive at low currents only such that there occur no further down-conversion losses.

Furthermore, a synchronous rectifier may be provided with a reduced overall size and a reduced number of components. Due the simple control which may be implemented with the synchronous rectifiers according to the present invention, the synchronous rectifiers are usable in an extensive variety of low-voltage power supply applications.

In response to trends attempting to avoid reducing the ac transformer secondary side voltage too far and responding to the fact that the secondary side output voltage provided by the transformer may not be controlled continuously (only on a winding increment basis), an overall need exists to provide a simple rectifier, allowing for a controlled low output voltage. Advantageously, according to the present invention, the coarse down-conversion of the voltage may be performed by the transformer. However, the rectification and the exact control of the lower output voltage of the rectifier is performed by the rectifier according to the present invention.

1. Method of operating a synchronous rectifier comprising a MOSFET, the method comprising the step of: controlling an output voltage of the synchronous rectifier by controlling the channel-switching of the MOSFET.

2. The method of claim 1, further comprising the steps of: determining a positive sign-change of a channel voltage such that the channel voltage becomes positive; performing an on-switching of the channel of the MOSFET a first time period after the positive sign-change of the channel voltage.

3. The method of claim 2, wherein the first time period is determined on the basis of a control error voltage.

4. The method of claim 1, determining a positive sign-change of a channel voltage such that the channel voltage becomes positive; performing an on-switching of the channel of the MOSFET upon detection of the positive sign change; and performing an off-switching of the channel of the MOSFET after a second period of time.

5. The method of claim 4, wherein the second time period is determined on the basis of a control error voltage.

6. The method of claim 1, wherein the channel switching of the MOSFET is duty-cycle modulated.

7. The method of claim 6, wherein the duty-cycle is controlled on the basis of the error voltage; and wherein the control of the duty-cycle is such that the larger the error voltage, the larger the duty-cycle.

8. The method of claim 1, further comprising the step of: low-pass filtering an output voltage of the synchronous rectifier with a time constant larger than a period of an input voltage of the synchronous rectifier; and performing the channel-switching of the MOSFET on the basis of the low-pass filtered output voltage.

9. Synchronous rectifier, comprising: a MOSFET; and an output voltage control circuit for controlling an output voltage of the synchronous rectifier by controlling the channel-switching of the MOSFET.

10. The synchronous rectifier of claim 9, wherein the output voltage control circuit is adapted to perform one of a first, second, third or fourth operation: a first operation where the output voltage control circuit determines a positive sign-change of a channel voltage such that the channel voltage becomes positive and performs an on-switching of the channel of the MOSFET a first time period after the positive sign-change of the channel voltage; a second operation where the output voltage control circuit determines the positive sign-change of the channel voltage such that the channel voltage becomes positive, performs an on-switching of the channel of the MOSFET upon detection of the positive sign change and performs an off-switching of the channel of the MOSFET after a second period of time.

11. The synchronous rectifier of claim 9, comprising: a first MOSFET; a first output voltage control circuit for controlling a first output voltage of the synchronous rectifier by controlling the channel-switching of the first MOSFET; a second MOSFET; and a second output voltage control circuit for controlling a second output voltage of the synchronous rectifier by controlling the channel-switching of the second MOSFET; wherein the first output voltage is stacked on the second output voltage.

12. The synchronous rectifier of claim 9, wherein the MOSFET and the output voltage control circuit are integrated in one package.

13. Output voltage control circuit for controlling an output voltage of a synchronous rectifier, wherein the output voltage control circuit controls the output voltage of the synchronous rectifier by controlling the channel-switching of a MOSFET of the synchronous rectifier.
